(19) United States
(12) Patent Application Publication
(10) Pub. No.: US 2007/0066715 A1
(43) Pub. Date: Mar. 22, 2007

(54) Process for manufacturing nonpolar thermoplastic materials containing inorganic particulates

(76) Inventors: Daniel H. Craig, Edmond, OK (US); John E. Eager, Edmond, OK (US); Jeffrey D. Elliott, Oklahoma City, OK (US); Michael E. Kidder, Piedmont, OK (US); George A. Perakis, Edmond, OK (US); Harmon E. Ray, Yukon, OK (US)

Correspondence Address: William B. Miller, 123 Robert S. Kerr Avenue, Oklahoma City, OK, 73102, US

(21) Appl. No.: 11/229,291

(22) Filed: Sep. 19, 2005

(51) Int. Cl. C08K 9/00

(52) U.S. Cl. 523/200; 106/503

(57) ABSTRACT

Processes are disclosed for treating an inorganic particulate to provide improved dispersibility in a nonpolar thermoplastic, for example, titanium dioxide as an opacifier or colorant in a polyolefin concentrate, and for producing said pigmented nonpolar thermoplastic, wherein a surface coating is applied to the particulate which comprises at least one of the polar phosphate esters containing acid and polar ether groups.

### FIELD OF THE INVENTION

This invention relates to processes for treating inorganic particulate materials and to processes for the manufacture of nonpolar thermoplastic materials containing said inorganic particulate materials, and especially to the treatment and use of inorganic pigments to produce pigmented nonpolar thermoplastics, such as pigmented polyethylene, pigmented polypropylene and pigmented polyvinyl chloride.

### BACKGROUND OF THE INVENTION

Inorganic pigments are used as opacifiers and colorants in many industries including the coatings, plastics, and paper industries. In general, the effectiveness of the pigment in such applications depends on how evenly the pigment can be dispersed. For this reason, pigments are generally handled in the form of a finely divided powder. For example, titanium dioxide, the most widely used white pigment in commerce today due to its ability to confer high opacity when formulated into end-use products, is handled in the form of a finely divided powder in order to maximize the opacifying properties imparted to materials formulated therewith. However, titanium dioxide powders are inherently dusty and frequently exhibit poor powder flow characteristics during the handling of the powder itself, especially during formulation, compounding, and manufacture of end-use products. While free-flowing powders with low dust properties can be obtained through known manufacturing practices, these powders usually exhibit reduced opacifying properties. To this end, chemical modification of titanium dioxide pigment surfaces has been the preferred approach to achieving the desired balance of pigment opacity and flow characteristics.

It is known in the art that the wetting and dispersing properties of titanium dioxide pigments can be improved by exposure to certain inorganic treatments, for example, depositing inorganic metal oxide and/or metal hydroxide coatings on the surface of the titanium dioxide.

Certain other chemical modifications of titanium dioxide pigment surfaces, involving treatment with organic compounds such as certain organic polyols, are also known to improve pigment performance, including helping to reduce the tendency of a pigment to adsorb moisture and to improve its gloss characteristics, particularly in coatings. In thermoplastics, improved pigment dispersion characteristics results in improved thermoplastics processing and uniformity of color. Organic chemical treatment of the pigment surface has also become the preferred method for achieving desired performance enhancements in cosmetics compositions, in paper and in inks, wherein the uniformity of pigment dispersion is critical. The most advantageous chemical composition for surface treatment in general will be dependent on the particular end use to which the titanium dioxide is put.

It is known to treat inorganic oxide pigment surfaces with organophosphorus compounds to enhance the compatibility between the oxide pigment and organic polymers, in order to improve the formulated organic polymer composition's performance properties, such as durability, surface aesthetics and/or higher processing throughput. Many patents have been issued disclosing methods for improving titanium dioxide pigments, wherein an organophosphorus compound is deposited on the pigment's surface prior to its incorporation into such end use materials as coatings, inks, in paper and in plastics as in the present invention.

U.S. Pat. No. 4,183,843, for instance, discloses an improved process for dispersing inorganic fillers in a polyester resin wherein the improvement comprises coating the filler with 0.05 to 1.0 percent, based on weight of the filler, of a polar phosphate ester surfactant containing acid groups and polar ether groups.

U.S. Pat. No. 4,186,028 describes improved fluid aqueous pigment dispersions, including titanium dioxide dispersions, using a phosphonocarboxylic acid or salt thereof as a dispersion aid.

U.S. Pat. No. 4,209,430 discloses improved inorganic pigments, such as pigmentary titanium dioxide, made by treating such pigments with a treating agent comprising the reaction product of a phosphorylating agent and a polyene. The treated pigments are useful in thermoplastic formulations and provide the additional benefit of suppressing yellowing in thermoplastic polyolefins containing a phenolic antioxidant and titanium dioxide.

U.S. Pat. No. 4,357,170 and U.S. Pat. No. 4,377,417 disclose titanium dioxide pigments treated to suppress yellowing in polymers, the treating composition comprising an organophosphate/alkanolamine addition product or a combination of an organophosphate/alkanolamine addition product and a polyol, respectively.

U.S. Pat. No. 5,318,625 and U.S. Pat. No. 5,397,391 disclose, respectively, thermoplastic pigment concentrates and pigments of improved dispersibility in thermoplastic resins, wherein an inorganic pigment such as titanium dioxide has an organophosphate triester treatment deposited thereon.

U.S. Pat. No. 5,837,049 describes a pigment, extender or filler, the particles of which are coated with an alkylphosphonic acid or ester thereof. The treated inorganic solid is particularly useful for preparing polymer compositions such as masterbatches.

U.S. Pat. No. 6,713,543 describes a unique treatment for pigments which uses certain organophosphoric acids and/or their salts, resulting in improved physical and chemical qualities, including lacing resistance, improved dispersion and decreased chemical reactivity when these treated pigments are incorporated into polymeric matrices.

Despite all the work and effort documented in the prior art relating to the development of improved organophosphorus treatments for pigments suited for use in pigmenting thermoplastics, further improvements are continually being sought. In none of the aforementioned references are such processes described which would anticipate the advantages achieved according to the instant invention, specifics of which are provided below.

### SUMMARY OF THE PRESENT INVENTION

The present invention concerns improved processes for treating an inorganic particulate to provide improved dispersibility of the inorganic particulate in a nonpolar thermoplastic, for example, titanium dioxide as an opacifier or colorant in a polyolefin concentrate, and for manufacturing a nonpolar thermoplastic material incorporating said inorganic particulate, wherein a surface coating is applied to the particulate which comprises at least one of the polar phosphate esters containing acid and polar ether groups.

U.S. Pat. No. 4,183,843 is more closely related in general to the present invention than other references which have been mentioned above, in describing the use of polar phosphate ester surfactants containing acid groups and polar ether groups in an improved process for dispersing inorganic fillers in a polyester resin. The '843 patent makes no mention, however, of treating an inorganic particulate such as titanium dioxide for incorporation in a nonpolar thermoplastic, such as a polyethylene, polypropylene or polyvinyl chloride masterbatch.

### DETAILED DESCRIPTION OF PREFERRED EMBODIMENTS OF THE PRESENT INVENTION

The polar phosphate esters contemplated by the instant invention comprise especially the polar phosphate esters containing acid groups and polar ether groups derived from the reaction of a phosphorus compound selected from phosphorus pentoxide, orthophosphoric acid and polyphosphoric acid with a nonionic adduct of ethylene oxide and an organic compound selected from the linear or branched aliphatic alcohols, linear or branched aliphatic-substituted aryl alcohols and aryl-substituted aryl alcohols. Preferred are polar phosphate esters derived from the nonionic adducts of ethylene oxide with linear or branched aliphatic alcohols or linear or branched aliphatic-substituted aryl alcohols, with from one to about ten moles of ethylene oxide per mole of linear or branched aliphatic alcohol or linear or branched aliphatic-substituted aryl alcohol. More preferred are polar phosphate esters derived from the nonionic adducts of ethylene oxide with linear or branched aliphatic alcohols, with from one to about ten moles of ethylene oxide per mole of linear or branched aliphatic alcohol. Most preferred are polar phosphate esters derived from the nonionic adducts of ethylene oxide with tridecyl alcohol, containing from one to about six moles of ethylene oxide per mole of tridecyl alcohol. Also contemplated are combinations of 50% by weight or greater of the aforementioned polar phosphate esters with other organic surface treatment materials known in the art for imparting improved processibility and performance properties to pigmented nonpolar thermoplastics in accordance with the instant invention.

The amount of such polar phosphate esters useful as pigment surface treatments according to the instant invention will be an amount sufficient to provide a pigmented nonpolar thermoplastic resin composition with improved processing properties over a nonpolar thermoplastic resin composition derived from the corresponding untreated pigment, preferably ranging from about 0.1 to about 5 weight percent of the polar phosphate esters, based on the weight of the pigment. More preferred is a polar phosphate ester content of about 0.25 percent to about 2.5 percent, based on the weight of the pigment. Most preferably, the surface treated inorganic pigment will use from about 0.5 percent to about 1.5 percent of a polar phosphate ester or esters including acid groups and polar ether groups, based on the weight of the inorganic particulate.

The particular polar phosphate esters useful as pigment surface treatments, and useful in imparting improved properties to nonpolar thermoplastics formulated with treated pigments, can be deposited onto the pigment surface using any of the known methods of treating the surfaces of inorganic pigments, such as deposition in a fluid energy mill, applying the treating agent to the dry pigment by mixing or spraying, or through the drying of pigment slurries containing said treating agent.

Inorganic pigments desirably improved by the instant invention include any of the particulate inorganic pigments conventionally known in the surface coatings and plastics industries. Examples include white opacifying pigments such as titanium dioxide, basic carbonate white lead, basic sulfate white lead, basic silicate white lead, zinc sulfide, zinc oxide; composite pigments of zinc sulfide and barium sulfate, antimony oxide and the like; white extender pigments such as calcium carbonate, calcium sulfate, china and kaolin clays, mica, diatomaceous earth; and colored pigments such as iron oxide, lead oxide, cadmium sulfide, cadmium selenide, lead chromate, zinc chromate, nickel titanate and chromium oxide. Most preferred is titanium dioxide of either the anatase or rutile crystalline structure or some combination thereof. The titanium dioxide pigment can have deposited thereon any of the inorganic metal oxide and/or metal hydroxide surface coatings known to the art, prior to treatment with the polar phosphate esters according to the instant invention.

Nonpolar thermoplastic compositions which possess improved properties with respect to polymer processing and end-use applications when formulated with pigments treated according to the instant invention comprise polyolefins such as polyethylene and polypropylene, polyvinyl chloride and their various copolymers and alloys.

The following examples serve to illustrate specific embodiments of the instant invention without intending to impose any limitations or restrictions thereto. Concentrations and percentages are by weight unless otherwise indicated.

### ILLUSTRATIVE EXAMPLES

### Example 1

Particulate titanium dioxide pigment intermediate obtained from the vapor phase oxidation of titanium tetrachloride and containing 1.5% alumina in its crystalline lattice, was dispersed in water in the presence of 0.18% by weight (based on the pigment) of sodium hexametaphosphate dispersant and with sodium hydroxide sufficient to adjust the pH of the dispersion to a minimum value of 9.5, to provide an aqueous dispersion having a solids content of 35% by weight. The resulting titanium dioxide slurry was sand milled, using a zircon sand-to-pigment weight ratio of 4 to 1, until a volume average particle size was achieved wherein >90% of the particles were smaller than 0.63 microns, as determined utilizing a Microtrac X1 00 Particle Size Analyzer (Microtrac Inc. Montgomeryville, Pa.). The slurry was heated to 60° C., acidified to a pH of 2.0 using concentrated sulfuric acid, then allowed to digest at 60° C. for 30 minutes. After this, adjustment of the pigment slurry pH to a value of 6.2 using 20% by weight aqueous sodium hydroxide solution was followed by digestion for an additional 30 minutes at 60° C., with final readjustment of the pH to 6.2, if necessary, at which point the dispersion was filtered while hot. The resulting filtrate was washed with an amount of water, which had been preheated to 60° C. and pre-adjusted to a pH of 7.0, equal to the weight of recovered pigment. The washed filtrate was subsequently re-dispersed in water with agitation, in the presence of 0.35% by weight based on pigment of trimethylol propane, to achieve a concentration of <40% by weight of dispersed pigment. The resulting pigment dispersion was spray dried using an APV Nordic PSD52 Spray Dryer (Invensys APV Silkeborg, Denmark), maintaining a dryer inlet temperature of approximately 280° C., to yield a dry pigment powder.

One thousand (1000) grams of the resulting pigment powder were thoroughly mixed with ten (10) grams of the mixed phosphate ester of the adduct formed from the reaction of three moles of ethylene oxide with one mole of tridecyl alcohol, to achieve a pigment surface coating concentration of 1% by weight based on the titanium dioxide. The dry powder mixture was subsequently roll milled for sixteen hours at room temperature, after which time the powder mixture was steam micronized, utilizing a steam to pigment weight ratio of five, with a steam injector pressure set at 146 psi and micronizer ring pressure set at 118 psi.

The resulting treated pigment sample was evaluated in titanium dioxide/polyethylene concentrates, according to the following procedure:

One hundred and nine and one-half (109.5) grams of the pigment was mixed with thirty-six and one-half (36.5) grams of Dow 4012 low density polyethylene, a product of The Dow Chemical Co., and 0.05% by weight based on polyethylene of an 80/20 mixture of tris(2,4-di-tertbutylphenyl)phosphite and octadecyl-3-(3,5-di-tertbutyl-4-hydroxyphenyl)propionate (available from Ciba Chemicals under the mark Irganox B-900), to prepare a 75% by weight titanium dioxide-containing polyethylene concentrate via mastication of the mixture in the mixing bowl of a Plasticorder Model PL-2000 (C.W. Brabender Instruments, Inc. South Hackensack, N.J.) at 100° C. and a mixing speed of 100 rpm. Instantaneous torque and temperature values were then recorded for a nine minute period to ensure equilibrium mixing conditions had been attained. Equilibrium torque values were determined via averaging the measured instantaneous torque values for a two minute period after equilibrium mixing conditions had been achieved. The resulting pigment concentrate was cooled and ground into pellets. The melt flow index value was determined on the resulting pellet concentrate using ASTM method 01238, procedure B. Maximum extruder processing pressure was determined by extruding 100 grams of the 75% concentrate through a 500 mesh screen filter using a 0.75 inch barrel, 25/1 length to diameter extruder attached to the aforementioned Brabender Plasticorder, at an average processing temperature of approximately 190° C. and at 75 rpm, while recording instrument pressure values at the extruder die. Results from these evaluations are provided in Table 1.

The same procedure was repeated using titanium dioxide produced according to the procedure outlined above but omitting the treatment with the mixed phosphate ester (Comparative Example 1).

TABLE 1
Processing Behavior of Titanium Dioxide-Containing
Polyethylene Concentrates

| | Melt Flow | | |
|---|---|---|---|
| | Index | Equilibrium | Max. Extruder |
| | (g/10 minutes: | Torque | Pressure |
| Pigment Sample: | 190 C.) | (meter-grams) | (psi) |
| Example 1 | 7 | 940 | 500 |
| Comp. Ex. 1 | <1 | 1570 | 970 |

The surface treated titanium dioxide-containing polyethylene thermoplastic concentrates produced according to the processes of the present invention, and wherein the titanium dioxide pigment possessed no additional inorganic surface treatment coating, thus demonstrate improved processibility and dispersibility as compared to concentrates produced conventionally without the surface treatment, as indicated by the higher melt flow index value, the lower equilibrium torque value, and the lower maximum extruder processing pressure.

### Example 2

Particulate titanium dioxide pigment intermediate obtained from the vapor phase oxidation of titanium tetrachloride and containing 1.5% alumina in its crystalline lattice was dispersed in water in the presence of 0.18% by weight (based on pigment) of sodium hexametaphosphate dispersant, along with sufficient sodium hydroxide to adjust the pH of the dispersion to a minimum value of 9.5, to yield an aqueous dispersion with a solids content of 35% by weight. The resulting titanium dioxide slurry was sand milled, using a zircon sand-to-pigment weight ratio of 4 to 1, until a volume average particle size was achieved wherein >90% of the particles were smaller than 0.63 microns, as determined utilizing a Microtrac X100 Particle Size Analyzer. The slurry was heated to 60° C., acidified to a pH of 2.0 using concentrated sulfuric acid, then allowed to digest for 30 minutes. After this, adjustment of the pigment slurry pH to a value of 6.2 using 20% by weight aqueous sodium hydroxide solution was followed by digestion for an additional 30 minutes at 60° C., with final readjustment of the pH to 6.2, if necessary, at which point the dispersion was filtered while hot. The resulting filtrate was washed with an amount of water, which had been preheated to 60° C. and pre-adjusted to a pH of 7.0, equal to the weight of recovered pigment. The washed filtrate was subsequently re-dispersed in water with agitation, in the presence of 0.35% by weight based on pigment of trimethylol propane, to achieve a concentration of <40% by weight of dispersed pigment. The resulting pigment dispersion was spray dried using an APV Nordic PSD52 Spray Dryer, maintaining a dryer inlet temperature of approximately 280° C., to yield a dry pigment powder.

One thousand (1000) grams of the resulting pigment powder were thoroughly mixed with ten (10) grams of the mixed phosphate ester of the adduct formed from the reaction of five moles of ethylene oxide with one mole of tridecyl alcohol to achieve a pigment surface coating concentration of 1% by weight based on titanium dioxide. The dry powder mixture was subsequently roll milled for sixteen hours at room temperature, after which time the powder mixture was steam micronized at a steam to pigment weight ratio of five, with a steam injector pressure set at 146 psi and micronizer ring pressure set at 118 psi.

The resulting finished pigment sample was evaluated in titanium dioxide/polyethylene concentrates, according to the following procedure:

One hundred and nine and one-half (109.5) grams of the finished pigment described above was mixed with thirty-six and one-half (36.5) grams of Dow 4012 low density polyethylene, and 0.05% by weight based on polyethylene of an 80/20 mixture of tris(2,4-di-tertbutylphenyl)phosphite and octadecyl-3-(3,5-di-tertbutyl-4-hydroxyphenyl)propionate, to prepare a 75% by weight titanium dioxide-containing polyethylene concentrate via mastication of the mixture in the mixing bowl of a Brabender Plasticorder Model PL-2000 at 100° C. and a mixing speed of 100 rpm. Instantaneous torque and temperature values were then recorded for a nine minute period to ensure equilibrium mixing conditions had been attained. Equilibrium torque values were determined via averaging the measured instantaneous torque values for a two minute period after equilibrium mixing conditions had been achieved. The resulting pigment concentrate was cooled and ground into pellets. The melt flow index value was determined on the resulting pellet concentrate using ASTM method D1238, procedure B. Maximum extruder processing pressure was determined by extruding 100 grams of the 75% concentrate through a 500 mesh screen filter using a 0.75 inch barrel, 25/1 length to diameter extruder attached to the aforementioned Brabender Plasticorder, at an average processing temperature of approximately 190° C. and at 75 rpm, while recording instrument pressure values at the extruder die. Results from these evaluations are provided in Table 2.

The same procedure was repeated using titanium dioxide produced according to the procedure outlined above but omitting the treatment with the mixed phosphate ester (Comparative Example 2).

TABLE 2
Processing Behavior of Titanium Dioxide
Containing Polyethylene Concentrates

| | Melt Flow | | |
|---|---|---|---|
| | Index | Equilibrium | Max. Extruder |
| | (g/10 minutes: | Torque | Pressure |
| Pigment Sample: | 190 C.) | (meter-grams) | (psi) |
| Example 2 | 3 | 990 | 600 |
| Comp. Example 2 | <1 | 1570 | 970 |

The surface treated titanium dioxide-containing polyethylene thermoplastic concentrates produced according to the processes of the present invention again demonstrated improved processibility and dispersibility as compared to concentrates produced conventionally without the surface treatment, as indicated by the higher melt flow index value, the lower equilibrium torque value, and the lower maximum extruder processing pressure.

### Example 3

Particulate titanium dioxide pigment intermediate obtained from the vapor phase oxidation of titanium tetrachloride and containing 0.8% alumina in its crystalline lattice, was dispersed in water in the presence of 0.18% by weight (based on the pigment) of sodium hexametaphosphate dispersant and with sodium hydroxide sufficient to adjust the pH of the dispersion to a minimum value of 9.5, to provide an aqueous dispersion having a solids content of 35% by weight. The resulting titanium dioxide slurry was sand milled, using a zircon sand-to-pigment weight ratio of 4 to 1, until a volume average particle size was achieved wherein >90% of the particles were smaller than 0.63 microns, as determined utilizing a Microtrac X100 Particle Size Analyzer. The slurry was heated to 60° C., acidified to a pH of 2.0 using concentrated sulfuric acid, then treated with 1% alumina, added as a 357 gram/liter aqueous sodium aluminate solution. During the addition of the sodium aluminate solution, the pH of the slurry was maintained between a value of 8.0 and 8.5 via addition of sulfuric acid, prior to digestion for 15 minutes at 60° C. After this, adjustment of the pigment slurry pH to a value of 6.2 using additional sulfuric acid was followed by digestion for an additional 15 minutes at 60° C., with final readjustment of the pH to 6.2, if necessary, at which point the dispersion was filtered while hot. The resulting filtrate was washed with an amount of water, which had been preheated to 60° C. and pre-adjusted to a pH of 7.0, equal to the weight of recovered pigment. The washed filtrate was subsequently re-dispersed in water with agitation, in the presence of 0.35% by weight based on pigment of trimethylol propane, to achieve a concentration of <40% by weight of dispersed pigment. The resulting pigment dispersion was spray dried using an APV Nordic PSD52 Spray Dryer, maintaining a dryer inlet temperature of approximately 280° C., to yield a dry pigment powder.

One thousand (1000) grams of the resulting pigment powder were thoroughly mixed with ten (1-0) grams of the mixed phosphate ester of the adduct formed from the reaction of three moles of ethylene oxide with one mole of tridecyl alcohol, to achieve a pigment surface coating concentration of 1% by weight based on the titanium dioxide. The dry powder mixture was subsequently roll milled for sixteen hours at room temperature, after which time the powder mixture was steam micronized, utilizing a steam to pigment weight ratio of five, with a steam injector pressure set at 146 psi and micronizer ring pressure set at 118 psi.

The resulting treated pigment sample was evaluated in titanium dioxide/polyethylene concentrates, according to the following procedure:

One hundred and nine and one-half (109.5) grams of the pigment was mixed with thirty-six and one-half (36.5) grams of Dow 4012 low density polyethylene, and 0.05% by weight based on polyethylene of an 80/20 mixture of tris(2,4-di-tertbutylphenyl)phosphite and octadecyl-3-(3,5-di-tertbutyl-4-hydroxyphenyl)propionate, to prepare a 75% by weight titanium dioxide-containing polyethylene concentrate via mastication of the mixture in the mixing bowl of a Plasticorder Model PL-2000 at 100° C. and a mixing speed of 100 rpm. Instantaneous torque and temperature values were then recorded for a nine minute period to ensure equilibrium mixing conditions had been attained. Equilibrium torque values were determined via averaging the measured instantaneous torque values for a two minute period after equilibrium mixing conditions had been achieved. The resulting pigment concentrate was cooled and ground into pellets. The melt flow index value was determined on the resulting pellet concentrate using ASTM method 01238, procedure B. Maximum extruder processing pressure was determined by extruding 100 grams of the 75% concentrate through a 500 mesh screen filter using a 0.75 inch barrel, 25/1 length to diameter extruder attached to the aforementioned Brabender Plasticorder, at an average processing temperature of approximately 190° C. and at 75 rpm, while recording instrument pressure values at the extruder die. Results from these evaluations are provided in Table 3.

The same procedure was repeated using titanium dioxide produced according to the procedure outlined above but omitting the treatment with the mixed phosphate ester (Comparative Example 3).

TABLE 3
Processing Behavior of Titanium Dioxide-Containing
Polyethylene Concentrates

| | Melt Flow | | |
|---|---|---|---|
| | Index | Equilibrium | Max. Extruder |
| | (g/10 minutes: | Torque | Pressure |
| Pigment Sample: | 190 C.) | (meter-grams) | (psi) |
| Example 1 | 7 | 1020 | 500 |
| Comp. Ex. 1 | <1 | 1550 | 880 |

The surface treated titanium dioxide-containing polyethylene thermoplastic concentrates produced according to the processes of the present invention, and wherein the titanium dioxide pigment had 1.0% by weight of alumina deposited on it prior to treatment with the mixed phosphate ester, thus also demonstrate improved processibility and dispersibility as compared to concentrates produced conventionally without the surface treatment, as indicated by the higher melt flow index value, the lower equilibrium torque value, and the lower maximum extruder processing pressure.

What is claimed is:

1. A process for improving the dispersibility of an inorganic particulate in a nonpolar thermoplastic, comprising applying a surface coating on the particulate which comprises at least one of the polar phosphate esters containing acid and polar ether groups.

2. A process as defined in claim 1, wherein the surface coating is accomplished by supplying one or more of the polar phosphate esters into a fluid energy mill wherein the inorganic particulate is being milled.

3. A process as defined in claim 1, wherein the surface coating is accomplished by spraying one or more of the polar phosphate esters onto or by mixing one or more of the polar phosphate esters into the dry inorganic particulate.

4. A process as defined in claim 1, wherein the surface coating is accomplished by adding one or more of the polar phosphate esters to a slurry of the inorganic particulate and then recovering the inorganic particulate from the slurry.

5. A process as defined in claim 1, wherein the inorganic particulate comprises titanium dioxide, basic carbonate white lead, basic sulfate white lead, basic silicate white lead, zinc sulfide, zinc oxide, a composite pigment of zinc sulfide and barium sulfate, antimony oxide, calcium carbonate, calcium sulfate, a china or kaolin clay, mica, diatomaceous earth; iron oxide, lead oxide, cadmium sulfide, cadmium selenide, lead chromate, zinc chromate, nickel titanate or chromium oxide.

6. A process as defined in claim 5, wherein a surface coating is applied such that the one or more polar phosphate esters comprise from about 0.1 to about 5 percent by weight of the inorganic particulate.

7. A process as defined in claim 6, wherein the inorganic particulate to which the surface coating is applied is titanium dioxide.

8. A process as defined in claim 7, wherein the inorganic particulate is coated with one or more polar phosphate esters containing acid groups and polar ether groups derived from the reaction of a phosphorus compound selected from phosphorus pentoxide, orthophosphoric acid and polyphosphoric acid with a nonionic adduct of ethylene oxide and an organic compound selected from the linear and branched aliphatic alcohols, the linear and branched aliphatic-substituted aryl alcohols and the aryl-substituted aryl alcohols.

9. A process as defined in claim 8, wherein the inorganic particulate is coated with one or more of polar phosphate esters derived from the nonionic adducts formed by the reaction of from one to ten moles of ethylene oxide and one mole of an alcohol selected from the linear and branched aliphatic alcohols and the linear and branched aliphatic-substituted aryl alcohols.

10. A process as defined in claim 9, wherein the inorganic particulate is coated with one or more of polar phosphate esters derived from the nonionic adducts formed by the reaction of from one to ten moles of ethylene oxide and one mole of an alcohol selected from the linear and branched aliphatic alcohols.

11. A process as defined in claim 10, wherein the inorganic particulate is coated with one or more of polar phosphate esters derived from the nonionic adducts formed by the reaction of from one to six moles of ethylene oxide and one mole of tridecyl alcohol.

12. A process as defined in claim 1, comprising depositing an oxide or hydroxide of a second inorganic metal on the inorganic particulate, before applying the surface coating comprising at least one of the polar phosphate esters containing acid and polar ether groups.

13. A process for manufacturing an inorganic particulate-containing nonpolar thermoplastic, comprising a) applying a surface coating on an inorganic particulate which comprises at least one of the polar phosphate esters containing acid and polar ether groups, and b) intimately mixing said treated inorganic particulate with a nonpolar thermoplastic material under temperature conditions wherein the nonpolar thermoplastic is at least partially melted for the duration of the mixing step.

14. A process as defined in claim 13, wherein the nonpolar thermoplastic is selected from the group comprising polyethylene, polypropylene, polyvinyl chloride and alloys thereof, and wherein the inorganic particulate is coated with one or more polar phosphate esters containing acid groups and polar ether groups derived from the reaction of a phosphorus compound selected from phosphorus pentoxide, orthophosphoric acid and polyphosphoric acid with a nonionic adduct of ethylene oxide and an organic compound selected from the linear and branched aliphatic alcohols, the linear and branched aliphatic-substituted aryl alcohols and the aryl-substituted aryl alcohols.

15. A process as defined in claim 13, wherein the nonpolar thermoplastic is selected from the group comprising polyethylene, polypropylene, polyvinyl chloride and alloys thereof, and wherein the inorganic particulate is coated with one or more of polar phosphate esters derived from the nonionic adducts formed by the reaction of from one to ten moles of ethylene oxide and one mole of an alcohol selected from the linear and branched aliphatic alcohols and the linear and branched aliphatic-substituted aryl alcohols.

16. A process as defined in claim 13, wherein the nonpolar thermoplastic is selected from the group comprising polyethylene, polypropylene, polyvinyl chloride and alloys thereof, and wherein the inorganic particulate is coated with one or more of polar phosphate esters derived from the nonionic adducts formed by the reaction of from one to ten moles of ethylene oxide and one mole of an alcohol selected from the linear and branched aliphatic alcohols.

17. A process as defined in claim 13, wherein the nonpolar thermoplastic is selected from the group comprising polyethylene, polypropylene, polyvinyl chloride and alloys thereof, and wherein the inorganic particulate is coated with one or more of polar phosphate esters derived from the nonionic adducts formed by the reaction of from one to six moles of ethylene oxide and one mole of tridecyl alcohol.
